(19) United States
(12) Patent Application Publication
(10) Pub. No.: US 2004/0157132 A1
(43) Pub. Date: Aug. 12, 2004

(54) Organic electrolytic solution for organic lithium sulfur battery and lithium sulfur battery using the same

(75) Inventors: Ju-yup Kim, Seoul (KR); Seok-soo Lee, Kyungki-do (KR); Young-gyoon Ryu, Kyungki-do (KR); Myung-dong Cho, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung SDI Co., Ltd., Kyungki-do (KR)

(21) Appl. No.: 10/694,815

(22) Filed: Oct. 29, 2003

(30) Foreign Application Priority Data
Nov. 16, 2002 (KR) 2002-71395

(51) Int. Cl. H01M 10/40; H01M 4/58; H01M 4/40; H01M 4/60

(52) U.S. Cl. 429/324; 429/199; 429/341; 429/329; 429/231.95; 429/213; 429/231.8

(57) ABSTRACT

A lithium sulfur battery including: a cathode that contains sulfur or a sulfur compound as an active material: an anode; a separator interposed between the cathode and the anode; and an organic electrolytic solution that contains a lithium salt, dialkoxypropane having the formula of (CH₂)₃R₁R₂, and an organic solvent are provided. The organic electrolytic solution, which contains dialkoxypropane, is less reactive with lithium of the anode and improves the conductivity of lithium ions and the discharging capacity and cycle properties of lithium sulfur batteries.

### BACKGROUND OF THE INVENTION

This application claims priority from Korean Patent Application No. 2002-71395, filed on Nov. 16, 2002, in the Korean Intellectual Property Office, the disclosure of which is incorporated herein in its entirety by reference.

1. Field of the Invention

The present invention relates to an organic electrolytic solution for a lithium sulfur battery and a lithium sulfur battery employing the same, and more particularly, to an organic electrolytic solution capable of improving the cycle efficiency and lifetime of a lithium sulfur battery, and a lithium sulfur battery using the same.

2. Description of the Related Art

With the rapid advance of compact portable electronic devices, there is an increasing need for batteries having high energy densities for miniature portable electronic devices. In addition, the development of more economical, safer, and more environmentally acceptable batteries is required.

Lithium sulfur batteries are known as the most promising types of batteries that are capable of satisfying the above requirements over other batteries developed by far due to their high energy density. Lithium and sulfolane (S₈) used as active materials in the manufacture of lithium sulfur batteries have an energy density of about 3,830 mAh/g and 1,675 mAh/g, respectively, and are known as being economical and environmentally friendly. However, there has been no successful commercial use of these active materials in battery systems.

The reason why it has been difficult to commercialize lithium sulfur batteries lies in the low availability of sulfur as an active material in electrochemical oxidation reactions, which finally leads to low battery capacity. In addition, the lifespan of batteries can be shortened due to the outflow of sulfur to electrolyte during oxidation and reduction reactions. If an unsuitable electrolytic solution is used, sulfur is reduced and separated as lithium sulfide (Li₂S) that is no longer available in electrochemical reactions.

To resolve these problems, many attempts have been made to optimize the composition of the electrolytic solution. As an example, U.S. Pat. No. 6,030,720 discloses the use of a mixture of a main solvent of R₁(CH₂CH₂O)ₙR₂ where n ranges from 2 to 10 and R is alkyl or alkoxy, and a co-solvent having 15 or greater donor number as an organic solvent of an electrolyte. The use of an electrolytic solution that contains at least one of crown ether, cryptand, and a doner solvent is also suggested.

U.S. Pat. No. 5,961,672 discloses the use of an organic electrolytic solution of 1 M LiSO₃CF₃ in a mixed solvent of 1,3-dioxolane, diglyme, sulfolane, and diethoxyethane in a ratio of 50:20:10:20 for the purpose of improving the lifespan and safety measures of batteries, wherein a polymeric film is formed on a lithium metal anode. U.S. Pat. No. 5,523,179 and U.S. Pat. No. 5,814,420 disclose the technical solutions to the problems described above.

When a lithium metal electrode is used as an anode of a lithium secondary battery, the performance of the battery deteriorates. In particular, as a result of repeated charging/discharging cycles, dendrites are separated and grow on the surface of the lithium metal anode to the surface of a cathode, thereby causing shorting out. In addition, the lithium metal corrodes as a result of reactions with an electrolytic solution at the surface of the lithium anode, so that the capacity of the battery drops.

As a solution to these problems, a method of forming a protecting layer on the surface of the lithium metal electrode has been suggested in U.S. Pat. Nos. 6,017,651, 6,025,094, and 5,961,672. To be effective, the protecting layer formed on the surface of the lithium electrode should allow lithium ions to pass through itself as well as act as a barrier to prevent an electrolytic solution from contacting the lithium metal of the anode.

Conventionally, this lithium-protecting layer is formed by the reaction of lithium and an additive contained in the electrolytic solution after the assembly of the battery. However, the protecting layer formed by this method has ineffective density, so that a considerable amount of electrolytic solution permeates through pores present in the protective layer and undesirably react with lithium metal.

Another method of forming a lithium-protecting layer involves processing the surface of a lithium electrode with nitrogen plasma to form a lithium nitride (Li₃N) layer on the electrode. However, the lithium nitride layer formed by this method includes grain boundaries through which the electrolytic solution easily permeates, is highly likely to decompose when in contact with water, and has a potential window as low as 0.45V. Therefore, the lithium nitride layer is impractical to use.

In general, the charging/discharging behavior of lithium secondary batteries greatly depends on the properties of films formed on the battery. Considerable research has been conducted into various lithium salts, solvents, and effects of additives, in order to improve the cycle efficiency of lithium metal.

Despite these efforts, the serious problem of dendric growth on lithium metal is yet unsettled. Furthermore, attempts to stabilize lithium with additives have failed to yield a perfect solution when lithium is used for the anode.

### SUMMARY OF THE INVENTION

The present invention provides an organic electrolytic solution for a lithium sulfur battery that is less reactive with lithium metal and improves the conductivity of lithium ions.

The present invention also provides a lithium sulfur battery with improved charging/discharging efficiency and discharging capacity by employing the above organic electrolyte solution.

In accordance with an aspect of the present invention, there is provided an organic electrolytic solution for a lithium sulfur battery, comprising a lithium salt and an organic solvent, wherein the organic solvent contains a compound of formula (1) below and an isomer thereof:

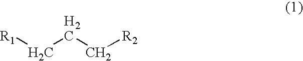

where R₁ and R₂ are independently selected from among a halogen atom, a hydroxy group, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ arylalkyl group, a substituted or unsubstituted C₆-C₃₀ aryloxy group, a substituted or unsubstituted C₂-C₃₀ heteroaryl group, a substituted or unsubstituted C₂-C₃₀ heteroarylalkyl group, a substituted or unsubstituted C₂-C₃₀ heteroaryloxy group, a substituted or unsubstituted C₅-C₂₀ cycloalkyl group, and a substituted or unsubstituted C₂-C₂₀ heterocycloalkyl group.

In accordance with another aspect of the present invention, there is provided a lithium sulfur battery comprising: a cathode that contains sulfur or a sulfur compound; an anode; a separator interposed between the cathode and the anode; and the above-described organic electrolytic solution.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph of change in charging/discharging cycle efficiency with respect to 1,3-dimethoxypropane (DMP) concentration for lithium sulfur batteries, wherein 0%, 10%, 30%, 50%, 70%, 90%, and 100% of DMP were added into a 1:1 mixture of diglyme (DGM) and dioxolane (DOX) to obtain 1M LiN(CF₃SO₂)₂ electrolytic solutions;

FIG. 2 is a bar graph illustrating charging/discharging cycle efficiency for lithium sulfur batteries manufactured using an electrolytic solution (A), which contains DOX, DGM, dimethoxyethane (DME), and sulfolane (SUL), and an electrolytic solution (B), which contains DOX, DGM, DMP, and SUL;

FIG. 3 is a bar graph illustrating charging/discharging cycle efficiency for lithium sulfur batteries manufactured using an electrolytic solution (A), which contains DGM, DME, and DOX, and an electrolytic solution (B), which contains DGM, DMP, and DOX;

FIG. 4 is a bar graph illustrating charging/discharging cycle efficiency for lithium sulfur batteries manufactured using an electrolytic solution (A), which contains DOX, DGM, DME, and SUL, an electrolytic solution (B), which contains DGM, DME, and DOX, an electrolytic solution (C), which contains DGM and DMP, an electrolytic solution (D), which contains DOX and DMP, an electrolytic solution (E), which contains TGM, DMP, and DOX, and an electrolytic solution (F), which contains DGM, DMP, and DOX;

FIG. 5 is a graph of change in discharging capacity with respect to number of charging/discharging cycles for three lithium sulfur batteries manufactured using an electrolytic solution having a solvent mixture of DGM, DOX, and DMP (first battery), DGM, DOX, and DME (second battery), and DGM, DOX, and dimethoxymethane (DMM) (third battery); and

FIG. 6 is a graph of change in discharging capacity with respect to number of charging/discharging cycles for three lithium sulfur batteries manufactured using an electrolytic solution having a solvent mixture of DGM, DOX, and DMP (first battery), DGM and DOX (second battery), and DGM, DOX, DME, and SUL (third battery).

### DETAILED DESCRIPTION OF THE INVENTION

Hereinafter, an organic electrolytic solution for a lithium sulfur battery and a lithium sulfur battery employing the organic electrolytic solution according to the present invention will be described in detail.

One of significant factors affecting the lifespan of lithium sulfur secondary batteries is the formation of dendrites on the surface of a lithium anode. The dendrites grow more with repeated charging/discharging cycles, causes shorting out of the battery, and adversely affects the battery lifespan.

When a lithium sulfur secondary battery is charged, a solid electrolyte interface (SEI) is formed on the surface of the anode as a result of decomposition of the electrolytic solution therein. This SEI effectively suppresses dentric growth and side reactions which occur at the anode surface and improves the battery lifespan. However, with repeated charging/discharging cycles of the battery, even the SEI deteriorates and the electrolytic solution decomposes more and more at the surface of the anode. Accordingly, in the present invention, a solvent incapable of dissolving at the surface of lithium metal is selected for an electrolytic solution so as to improve the cycle efficiency of the lithium metal. In particular, a binary or ternary electrolytic solution is prepared by adding a solvent capable of improving the cycle efficiency of the lithium metal, i.e., a disubstituted propane of formula (1) above or an isomer thereof.

Examples of an unsubstituted C₁-C₂₀ alkyl group as a substituent for R₁ and R₂ in formula (1) above include a methyl group, an ethyl group, a propyl group, an isobutyloxy group, a sec-butyl group, a pentyl group, an iso-amyl group, a hexyl group, and the like, wherein at least one hydrogen atom of the alkyl group may be substituted with a halogen atom, a hydroxy group, a nitro group, a cyano group, an amino group, an amidino group, hydrazine, hydrazone, a carboxy group, a sulfonic acid group, a phosphoric acid group, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, or a C₆-C₂₀ heteroarylalkyl group.

Examples of an unsubstituted C₁-C₂₀ alkoxy group as a substituent for R₁ and R₂ in formula (1) above include a methoxy group, an ethoxy group, a propoxy group, an isobutyl group, a sec-butyloxy group, a pentyloxy group, an iso-amyloxy group, a hexyloxy group, and the like, wherein at least one hydrogen atom of the alkoxy group may be substituted with any substituent described above as being suitable for the C₁-C₂₀ alkyl group.

The aryl group as a substituent for R₁ and R₂ in formula (1) above means a C₆-C₃₀ carbocyclic aromatic system containing at least one ring wherein such rings may be attached together in a pendent manner or may be fused. The term “aryl” embraces aromatic radicals, such as phenyl, naphthyl, tetrahydronaphthyl, and the like. The aryl group may have a substituent such as haloalkyl, nitro, cyano, alkoxy, and lower alkylamino. At least one hydrogen atom of the aryl group may be substituted with any substituent described above as being suitable for the C₁-C₂₀ alkyl group.

Examples of an aryloxy group as a substituent for R₁ and R₂ in formula (1) above include a phenoxy group, a naphthoxy group, etc. At least one hydrogen atom of the aryloxy group may be substituted with any substituent described above as being suitable for the C₁-C₂₀ alkyl group.

The arylalkyl group as a substituent for R₁ and R₂ in formula (1) above means the above-defined aryl group having lower alkyl substituents, for example, methyl, ethyl, propyl, and the like for some hydrogen atoms. Examples of an arylalkyl group include benzyl, phenylethyl, etc. At least one hydrogen atom of the arylalkyl group may be substituted with any substituent described above as being suitable for the C₁-C₂₀ alkyl group.

The heteroaryl group as a substituent for R₁ and R₂ in formula (1) above means a C₂-C₃₀ monocyclic system containing one, two, or three hetero atoms selected from the group consisting of N, O, P, and S and having at least one ring wherein such rings may be attached together in a pendent manner or may be fused. At least one hydrogen atom of the heteroaryl group can be substituted with any substituent described above as being suitable for the C₁-C₂₀ alkyl group.

The heteroarylalkyl group as a substituent for R₁ and R₂ in formula (1) above means the above-defined heteroaryl group having lower alkyl substitute groups for some hydrogen atoms, wherein at least one hydrogen atom of the heteroarylalkyl group may be substituted with any substituent described above as being suitable for the C₁-C₂₀ alkyl group.

The cycloalkyl group as a substituent for R₁ and R₂ in formula (1) above means a C₄-C₃₀ monovalent monocyclic system, wherein at least one hydrogen atom of the cycloalkyl group may be substituted with any substituent described above as being suitable for the C₁-C₂₀ alkyl group.

The heterocycloalkyl group as a substituent for R₁ and R₂ in formula (1) above means a C₁-C₃₀ monovalent monocyclic system containing one, two, or three hetero atoms selected from the group consisting of N, O, P, and S and having lower alkyl groups for some hydrogen atoms, wherein at least one hydrogen atom of the heterocycloalkyl group may be substituted with any substituent described above as being suitable for the C₁-C₂₀ alkyl group.

The disubstituted propane of formula (1) above has compound of formulae (2), (3), and (4) below as an isomer:

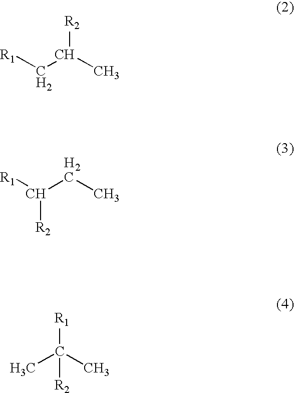

The amount of compound having one of formula (1) or an isomer thereof is in a range of, preferably, 9-95% by volume, more preferably, 20-80% by volume, based on the total volume of the the organic solvent. If the amount of the compound of formula (1) or an isomer thereof is less than 5%, the effect of stabilizing lithium metal is insignificant. If the amount of the compound of formula (1) or an isomer thereof exceeds 95%, the effect of improving the performance of a cathode degrades, without further improvement in the lithium metal stabilizing effect.

The present invention is illustrated in more detail by the following examples and not intended to limit the scope of the invention.

### EXAMPLE 1

An electrode assembly including a cathode, an anode, and a polyethylene separator (ASHAI CO., Japan) between the cathode and the anode was manufactured, wherein lithium metal electrodes were used for the cathode and the anode.

The electrode assembly was sealed in a battery case, and an organic electrolytic solution according to the present invention was injected to provide a complete lithium sulfur battery (coin cell 2016). The organic electrolytic solution contained 1M LiN(SO₂CF₃)₂ as a lithium salt and a mixture of 1,3-dioxane (DOX) and diglyme (DGM) in a ratio of 1:1 by volume and further 1,3-dimethoxypropane (DMP) as an organic solvent. The charging/discharging cycle efficiency of the lithium sulfur battery was measured.

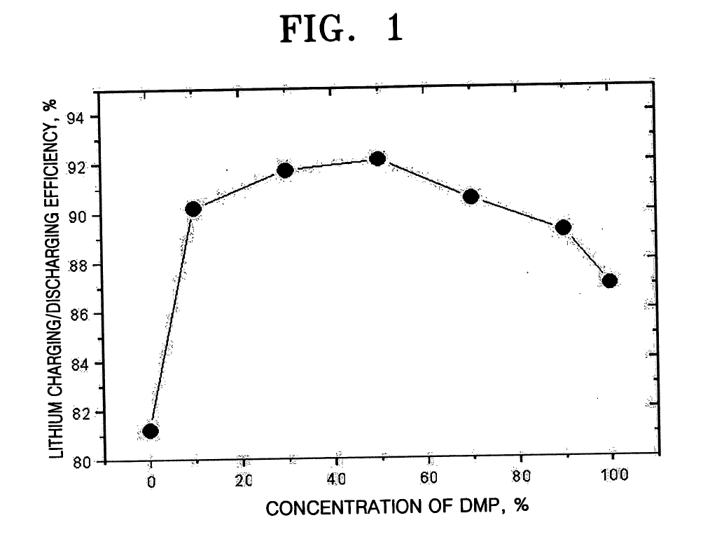

As is apparent from FIG. 1, the charging/discharging efficiency is greatest at about 50% by volume of 1,3-DMP in the electrolytic solution among other DMP concentrations.

### EXAMPLE 2

A lithium sulfur battery was manufactured in the same manner as in Example 1, except that 1M LiCF₃SO₃ was used as a lithium salt and a mixture of 1,3-dioxane (DOX), diglyme (DGM), 1,3-dimethoxypropane (DMP), and sulfolane (SUL) in a ratio of 5:2:2:1 by volume was used as an organic solvent to obtain an organic electrolytic solution. The charging/discharging cycle efficiency of the lithium sulfur battery was measured.

### COMPARATIVE EXAMPLE 1

A lithium sulfur battery was manufactured in the same manner as in Example 1, except that 1M LiCF₃SO₃ was used as a lithium salt and a mixture of 1,3-dioxane (DOX), diglyme (DGM), 1,3-dimethoxyethane (DME), and sulfolane (SUL) in a ratio of 5:2:2:1 by volume was used as an organic solvent to obtain an organic electrolytic solution. The charging/discharging cycle efficiency of the lithium sulfur battery was measured.

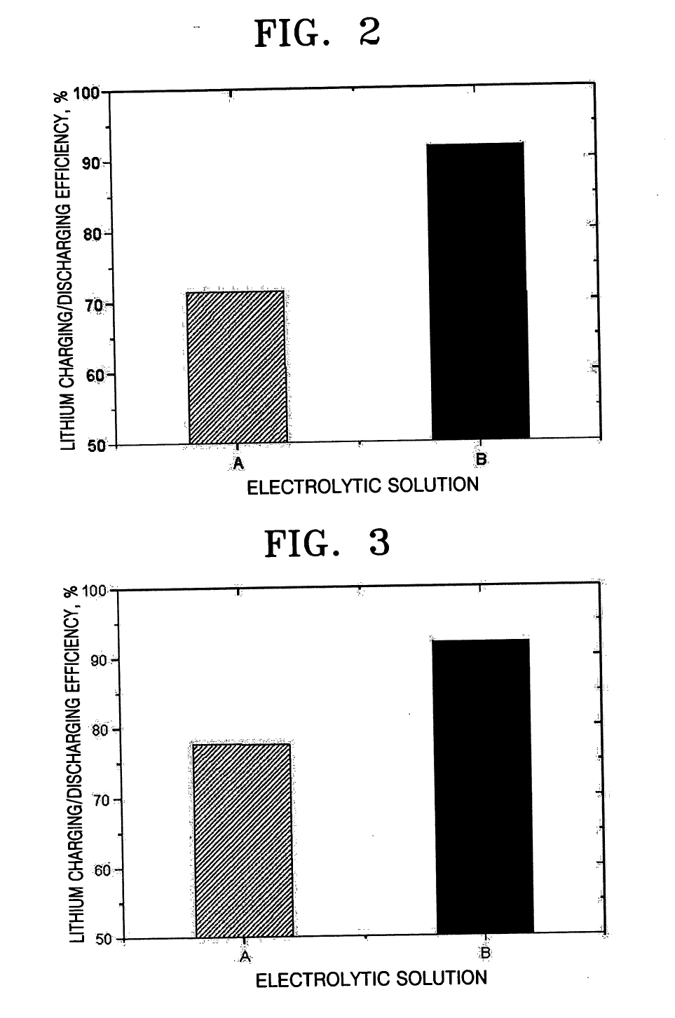

FIG. 2 is a bar graph illustrating charging/discharging efficiency for the lithium sulfur batteries manufactured in Comparative Example 1 (A) and Example 2 (B). As is apparent from FIG. 2, the charging/discharging efficiency is improved by 10-15% for the lithium sulfur battery containing DMP, compared to the lithium sulfur battery containing DME instead of DMP.

### EXAMPLE 3

A lithium sulfur battery was manufactured in the same manner as in Example 1, except that a mixture of DGM, DMP, and DOX in a ratio of 4:4:2 by volume was used as an organic solvent for the organic electrolytic solution, 1M Li(CF₃SO₂)₂. The charging/discharging cycle efficiency of the lithium sulfur battery was measured.

### COMPARATIVE EXAMPLE 2

A lithium sulfur battery was manufactured in the same manner as in Example 1, except that a mixture of DGM, DME, and DOX in a ratio of 4:4:2 by volume was used as an organic solvent for the organic electrolytic solution, 1M Li(CF₃SO₂)₂. The charging/discharging cycle efficiency of the lithium sulfur battery was measured.

FIG. 3 is a bar graph illustrating charging/discharging efficiency for the lithium sulfur batteries manufactured in Comparative Example 2 (A) and Example 3 (B). As is apparent from FIG. 3, the charging/discharging efficiency is improved by 10-20% for the lithium sulfur battery containing DMP, compared to the lithium sulfur battery containing DME instead of DMP.

### EXAMPLE 4

A lithium sulfur battery was manufactured in the same manner as in Example 1, except that a mixture of DGM and DMP in a ratio of 1:1 by volume was used as an organic solvent for the organic electrolytic solution, 1M Li(CF₃SO₂)₂. The charging/discharging cycle efficiency of the lithium sulfur battery was measured.

### EXAMPLE 5

A lithium sulfur battery was manufactured in the same manner as in Example 1, except that a mixture of DOX and DMP in a ratio of 1:1 by volume was used as an organic solvent for the organic electrolytic solution, 1M Li(CF₃SO₂)₂. The charging/discharging cycle efficiency of the lithium sulfur battery was measured.

### EXAMPLE 6

A lithium sulfur battery was manufactured in the same manner as in Example 1, except that a mixture of triglyme (TGM), DMP, and DOX a ratio of 4:4:2 by volume was used as an organic solvent for the organic electrolytic solution, 1M Li(CF₃SO₂)₂. The charging/discharging cycle efficiency of the lithium sulfur battery was measured.

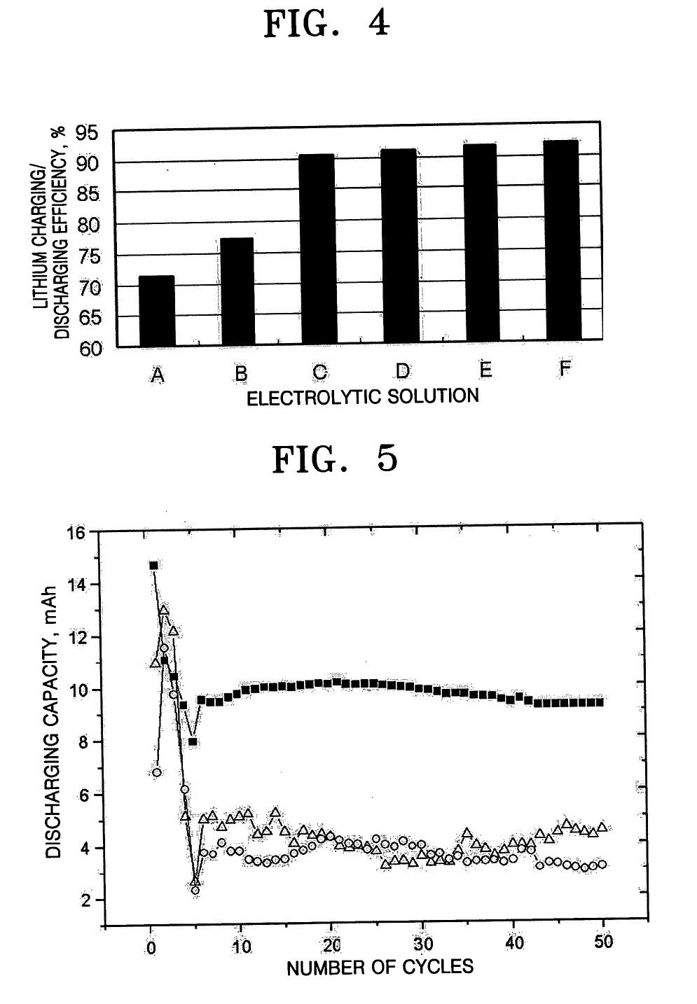

FIG. 4 is a bar graph illustrating charging/discharging efficiency for the lithium sulfur batteries manufactured in Comparative Example 2 (A), Comparative Example 2 (B), Example 4 (C), Example 5 (D), Example 6 (E), and Example 3 (F). As is apparent from FIG. 4, the charging/discharging efficiency is improved by 10-15% for the lithium sulfur batteries containing DMP, compared to the lithium sulfur batteries containing DME instead of DMP.

### COMPARATIVE EXAMPLE 3

A lithium sulfur battery was manufactured in the same manner as in Example 1, except that a mixture of DGM, dimethoxymethane (DME), and DOX in a ratio of 4:4:2 by volume was used as an organic solvent for the organic electrolytic solution, 1M Li(CF₃SO₂)₂. The discharging capacity of the lithium sulfur battery was measured.

FIG. 5 is a graph of change in discharging capacity with respect to the number of charging/discharging cycles for the lithium sulfur batteries manufactured in Example 3 (-▪-), Comparative Example 2 (-◯-), and Comparative Example 3 (-Δ-). As is apparent from FIG. 5, the discharging capacity is improved by 40-50% for the lithium sulfur battery containing DGM, DMP, and DOX in a ratio of 4:4:2 by volume, compared to the lithium batteries which contain DME or DMM instead of DMP.

### COMPARATIVE EXAMPLE 4

A lithium sulfur battery was manufactured in the same manner as in Example 1, except that a mixture of DGM and DOX in a ratio of 1:1 by volume was used as an organic solvent for the organic electrolytic solution, 1M Li(CF₃SO₂)₂. The discharging capacity of the lithium sulfur battery was measured.

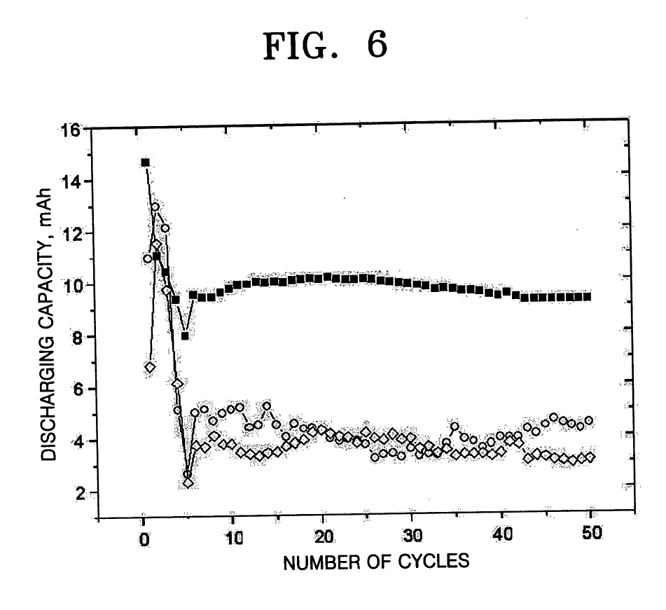

FIG. 6 is a graph of change in discharging capacity with respect to the number of charging/discharging cycles for the lithium sulfur batteries manufactured in Example 3 (-▪-), Comparative Example 4 (-◯-), and Comparative Example 1 (-Δ-). As is apparent from FIG. 6, the discharging capacity is improved by 40-50% for the lithium sulfur battery containing DGM, DMP, and DOX in a ratio of 4:4:2 by volume, compared to the lithium batteries which do not contain DMP or contain DME instead of DMP.

As described above, the composition of an organic electrolytic solution according to the present invention lowers the reactivity of lithium metal and stabilizes the lithium metal. The organic electrolytic solution also improves the ionic conductivity of lithium and improves the performance of lithium batteries. A solvent of the organic electrolytic solution according to the present invention more contributes to improving the charging/discharging cycle and the discharging capacity of lithium sulfur batteries than conventional electrolytic solutions.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic electrolytic solution for a lithium sulfur battery, comprising a lithium salt and an organic solvent, wherein the organic solvent contains a compound of formula (1) below and an isomer thereof: 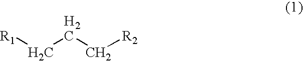
where R₁ and R₂ are independently selected from among a halogen atom, a hydroxy group, a substituted or unsubstituted C₁-C₂₀ alkyl group, a substituted or unsubstituted C₁-C₂₀ alkoxy group, a substituted or unsubstituted C₆-C₃₀ aryl group, a substituted or unsubstituted C₆-C₃₀ arylalkyl group, a substituted or unsubstituted C₆-C₃₀ aryloxy group, a substituted or unsubstituted C₂-C₃₀ heteroaryl group, a substituted or unsubstituted C₂-C₃₀ heteroarylalkyl group, a substituted or unsubstituted C₂-C₃₀ heteroaryloxy group, a substituted or unsubstituted C₅-C₂₀ cycloalkyl group, and a substituted or unsubstituted C₂-C₂₀ heterocycloalkyl group.

2. The organic electrolytic solution of claim 1, wherein both R₁ and R₂ in said formula (1) are methoxy groups as in formula (2) below:

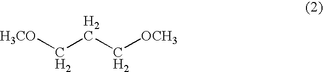

3. The organic electrolytic solution of claim 1, wherein the organic electrolytic solution further contains at least one of a polyglyme and a dioxolane.

4. The organic electrolytic solution of claim 3, wherein the polyglyme is selected from the group consisting of diethyleneglycol dimethylether (CH₃(OCH₂CH₂)₂OCH₃), diethyleneglycol diethylether (C₂H₅(OCH₂CH₂)₂OC₂H₅), triethyleneglycol dimethylether (CH₃(OCH₂CH₂)₃OCH₃), and triethyleneglycol diethylether (C₂H₅(OCH₂CH₂)₃OC₂H₅).

5. The organic electrolytic solution of claim 3, wherein the dioxolane is selected from the group consisting of 1,3-dioxolane, 4,5-diethyl-dioxolane, 4,5-dimethyl-dioxolane, 4-methyl-1,3-dioxolane, and 4-ethyl-1,3-dioxolane.

6. The organic electrolytic solution of claim 3, wherein the amount of at least one of the polyglyme and the dioxolane is in a range of 5-95% by volume, and the amount of the compound of said formula (1) or an isomer thereof is in a range of 5-95% by volume, based on the total volume of the organic solvent.

7. The organic electrolytic solution of claim 3, wherein the polyglyme and the oxolane are mixed in a ratio of 1:9-9:1 by volume.

8. The organic electrolytic solution of claim 3, wherein the organic electrolytic solution further contains at least one selected from the group consisting of sulfolane, dimethoxyethane, and diethoxyethane.

9. The organic electrolytic solution of claim 1, wherein the lithium salt has a concentration of 0.5-2.0M.

10. A lithium sulfur battery comprising:
a cathode that contains sulfur or a sulfur compound;
an anode;
a separator interposed between the cathode and the anode; and
the organic electrolytic solution of claim 1.

11. The lithium sulfur battery of claim 10, wherein the cathode is formed of at least one selected from the group consisting of a simple substance sulfur, Li₂Sₙ where n≧1, kasolite containing Li₂Sₙ where n≧1, organo-sulfur, and a carbon-sulfur composite polymer expressed as (C₂Sₓ)ₙ where x ranges from 2.5 to 50 and n≧2.

12. The lithium sulfur battery of claim 10, wherein the anode is formed as a lithium metal electrode, a lithium-metal alloy electrode, a lithium-inert sulfur composite electrode, a carbonaceous electrode, or a graphite electrode.

13. A lithium sulfur battery comprising:
a cathode that contains sulfur or a sulfur compound;
an anode;
a separator interposed between the cathode and the anode; and
the organic electrolytic solution of claim 2.

14. The lithium sulfur battery of claim 13, wherein the cathode is formed of at least one selected from the group consisting of a simple substance sulfur, Li₂Sₙ where n≧1, kasolite containing Li₂Sₙ where n≧1, organo-sulfur, and a carbon-sulfur composite polymer expressed as (C₂Sₓ)ₙ where x ranges from 2.5 to 50 and n≧2.

15. The lithium sulfur battery of claim 13, wherein the anode is formed as a lithium metal electrode, a lithium-metal alloy electrode, a lithium-inert sulfur composite electrode, a carbonaceous electrode, or a graphite electrode.

16. A lithium sulfur battery comprising:
a cathode that contains sulfur or a sulfur compound;
an anode;
a separator interposed between the cathode and the anode; and
the organic electrolytic solution of claim 3.

17. The lithium sulfur battery of claim 16, wherein the cathode is formed of at least one selected from the group consisting of a simple substance sulfur, Li₂Sₙ where n≧1, kasolite containing Li₂Sₙ where n≧1, organo-sulfur, and a carbon-sulfur composite polymer expressed as (C₂Sₓ)ₙ where x ranges from 2.5 to 50 and n≧2.

18. The lithium sulfur battery of claim 16, wherein the anode is formed as a lithium metal electrode, a lithium-metal alloy electrode, a lithium-inert sulfur composite electrode, a carbonaceous electrode, or a graphite electrode.

19. A lithium sulfur battery comprising:
a cathode that contains sulfur or a sulfur compound;
an anode;
a separator interposed between the cathode and the anode; and
the organic electrolytic solution of claim 4.

20. The lithium sulfur battery of claim 19, wherein the cathode is formed of at least one selected from the group consisting of a simple substance sulfur, Li₂Sₙ where n≧1, kasolite containing Li₂Sₙ where n≧1, organo-sulfur, and a carbon-sulfur composite polymer expressed as (C₂Sₓ)ₙ where x ranges from 2.5 to 50 and n≧2.

21. The lithium sulfur battery of claim 19, wherein the anode is formed as a lithium metal electrode, a lithium-metal alloy electrode, a lithium-inert sulfur composite electrode, a carbonaceous electrode, or a graphite electrode.
